(19) United States
(12) Patent Application Publication
(10) Pub. No.: US 2009/0216665 A1
(43) Pub. Date: Aug. 27, 2009

(54) Systems and Methods for Providing Vending Network Data Management

(75) Inventors: Stephen Merwarth, Cumming, GA (US); Leonard Antao, Smyrna, GA (US); Gerard E. Insolia, Atlanta, GA (US); H. Brock Kolls, Alpharetta, GA (US)

Correspondence Address: SUTHERLAND ASBILL & BRENNAN LLP, 999 PEACHTREE STREET, N.E., ATLANTA, GA, 30309, US

(73) Assignee: THE COCA-COLA COMPANY, Atlanta, GA (US)

(21) Appl. No.: 12/035,174

(22) Filed: Feb. 21, 2008

(51) Int. Cl. G06Q 40/00

(52) U.S. Cl. 705/30

(57) ABSTRACT

Embodiments of the invention can implement systems and methods for providing vending network data management. In one embodiment, a system for vending network data management can be provided. The system can include a vend settlement manager program module operable to receive a plurality of electronic transactions from at least one transaction-type device. The vend settlement manager program module can be further operable to reconcile the plurality of electronic transactions. Furthermore, the vend settlement manager program module can be operable to communicate response data for each electronic transaction to at least one server.

### TRADEMARKS

COCA-COLA® is a registered trademark of The Coca-Cola Company, Atlanta, Ga., U.S.A. Other names used herein may be registered trademarks, trademarks or product names of The Coca-Cola Company or other companies.

### TECHNICAL FIELD OF THE INVENTION

This invention relates to a vending network, and more particularly to systems and methods for providing vending network data management.

### BACKGROUND OF THE INVENTION

In the vending industry, coins and bills have been one manner used to pay for vended goods and services. In this regard, when a vending account is to be settled, coins and bills can be collected from vending equipment, and the coins and bills can be reconciled with the physical inventory to determine what was sold and how much money was collected.

In recent years, cashless payments, for example credit cards, have become an option for payments. In this regard, a user of vending equipment may now be able to use cashless payments, in addition to coin and bill payments, for vended goods and services. In the case of cashless payments, a cashless payment can typically be processed by a third party server. Subsequently, an electronic funds transfer (EFT) can remit the cashless payment received, less any transaction processing fees and/or other fees, to an operator of the vending equipment. Even so, in some instances, the EFT may not reconcile an actual vend event with an associated actual cashless transaction. To further complicate matters, the vend sale amount may not match the EFT amount since fees may be deducted from the cashless funds, and oftentimes, the EFT transactions may represent an aggregated batch or bundling of multiple transactions, thus obscuring each individual vend transaction.

The processing of cashless transactions can cause numerous problems for processors handling cashless transactions, vendors offering goods and/or services by way of a vending machine accepting cashless transactions, and others involved in the cashless transaction process. For example, in one settlement process, coins, bills, and cashless transactions may not be timely reconciled with inventory since many cashless transactions may still be stored in a vending machine or other associated data storage device. In other instances, cashless transactions may still be en route to a third party server, not settled yet and/or aggregated with little or no transaction level detail. Oftentimes, only after vend settlement is initiated, may an associated EFT transaction occur, which can further frustrate the settlement process because of the aggregated nature of EFTs.

In addition, the routing of cashless transactions to one or more third party servers can also create an accountability problem. In some instances, multiple items can be vended from a vending machine, and one or more customers may attempt to pay with a cashless implement, such as a credit or debit card. However, in such instances, there is no guarantee that a vending equipment operator will ever see funds for vends paid for by cashless transactions, and no further guarantee that a customer was correctly charged for the vended goods and/or services. As such, there may be little or no accountability as to when vends occurred or what was charged to the customer. Moreover, there may be little or no accountability as to whether a customer was timely and accurately charged, and little or no assurance that a vending equipment operator timely received the correct funds for vends paid for by cashless transactions.

Furthermore, a problem exists in auditing third party servers to verify accuracy and/or correctness of cashless transactions. In this regard, cashless transaction vending can lack oversight, accountability, auditing controls, and the ability to control how a device in the vending equipment operates and how data is communicated with or between various servers or other data processing devices.

Another problem occurs when route personnel attempt to reconcile transaction amounts and inventory at a vending equipment location. In some instances, the amount of bills, coins, cashless vends, and inventory must be known at the same point in time. As related to cashless transactions, this means knowing what the value of each transaction is without any fees removed, knowing which of the cashless transactions have been settled, and also knowing which of the settled cashless transactions have a corresponding EFT record indicating that an operator of the vending equipment has been paid for the cashless transactions. Without this level of detail, it may be unlikely that an accurate or timely vending equipment settlement can be performed without error across multiple vending equipment locations. For vending equipment in global locations, the settlement process may not be performed efficiently.

Therefore, a need exists for systems and methods for providing vending network data management.

### SUMMARY OF THE INVENTION

Some or all of the above needs can be addressed by various embodiments of the invention. Embodiments of the invention can provide systems and methods for providing vending network data management.

In one embodiment, a system for vending network data management can be provided. The system can include a vend settlement manager program module operable to receive a plurality of electronic transactions from at least one transaction-type device. The vend settlement manager program module can be further operable to reconcile the plurality of electronic transactions. Furthermore, the vend settlement manager program module can be operable to communicate response data for each electronic transaction to at least one server.

In another embodiment, a method for providing vending network data management can be provided. The method can include receiving a plurality of electronic transactions from at least one transaction-type device. In addition, the method can include reconciling the plurality of electronic transactions. Furthermore, the method can include communicating response data for each electronic transaction to at least one server switch.

In yet another embodiment, a computer-readable medium including program instructions can be provided. The program instructions can be operable to receive a plurality of electronic transactions from at least one transaction-type device. Furthermore, the program instructions can be operable to reconcile the plurality of electronic transactions. Moreover, the program instructions can be operable to communicate response data for each electronic transaction to at least one server.

Other embodiments and aspects of the invention are described in detail herein and are considered a part of the claimed invention. For a better understanding of embodiments of the invention with features and aspects, refer to the description and to the drawings.

### BRIEF DESCRIPTION OF THE FIGURES

The foregoing and other features and aspects of the invention are apparent from the following detailed description taken in conjunction with the accompanying drawings in which:

FIG. 1 illustrates an example vending network data management system in accordance with an embodiment of the invention.

FIG. 2 illustrates an example system for providing vending network data management in accordance with an embodiment of the invention.

FIG. 3 illustrates an example program module or set of computer-readable instructions operable to effectuate vend settlement of at least one vending machine in accordance with an embodiment of the invention.

FIG. 4 illustrates an example method of settling transactions associated with vending equipment in accordance with an embodiment of the invention.

### DETAILED DESCRIPTION OF EMBODIMENTS OF THE INVENTION

As used herein, the term “transaction” can refer to a cash or cashless payment associated with a purchase of a good and/or service. Embodiments of the invention are intended to cover any combination of cash and/or cashless payments or transactions as well as payments or transactions relating to any combination of goods and/or services.

As used herein, the terms “server switch” and “server” can be used interchangeably. Embodiments of the invention are intended to cover any combination of servers, server switches, or other processing devices with similar functionality to a server or server switch.

As used herein, the terms “reconciliation token” and “unique identifier” can be used interchangeably. Embodiments of the invention are intended to cover any type of unique identifier including, but not limited to, a reconciliation token or any other device, code, or identifying instrument with similar functionality.

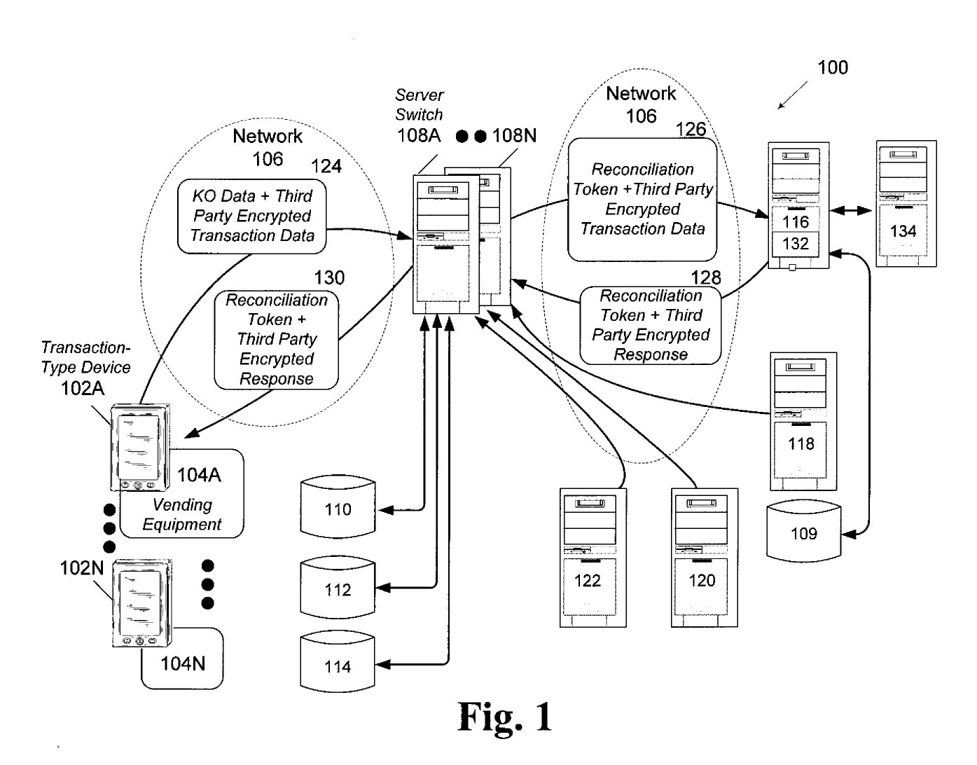

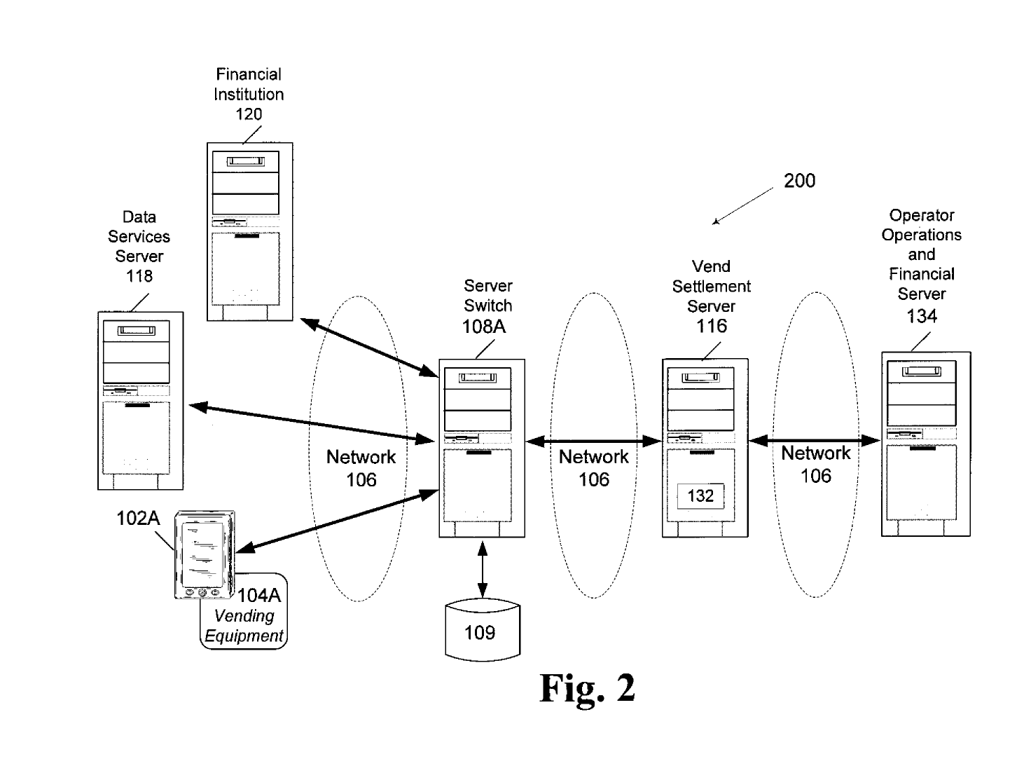

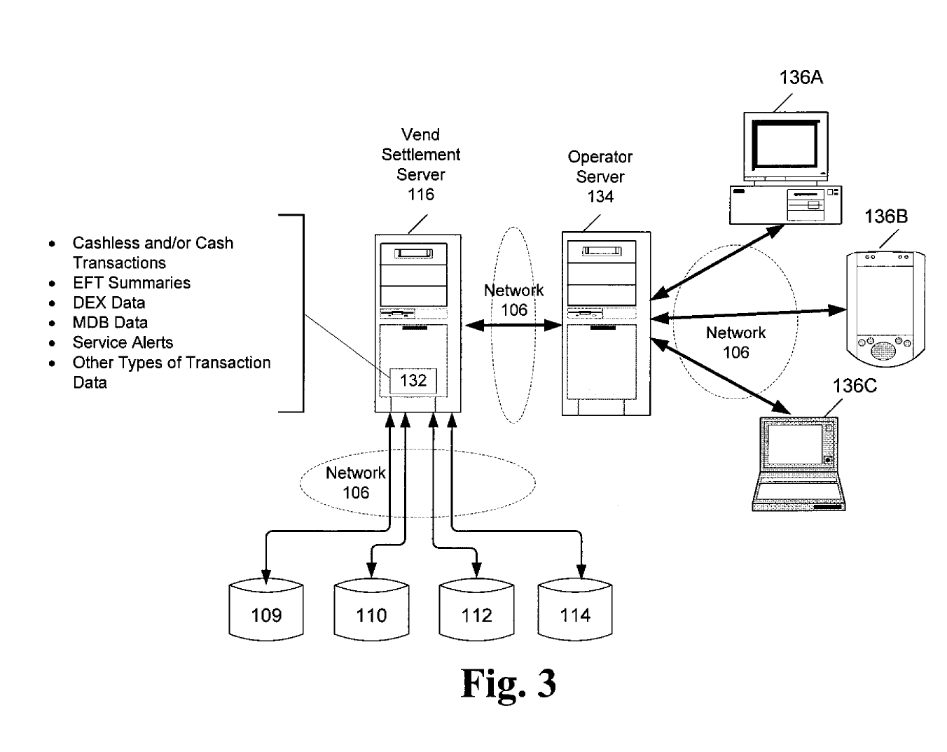

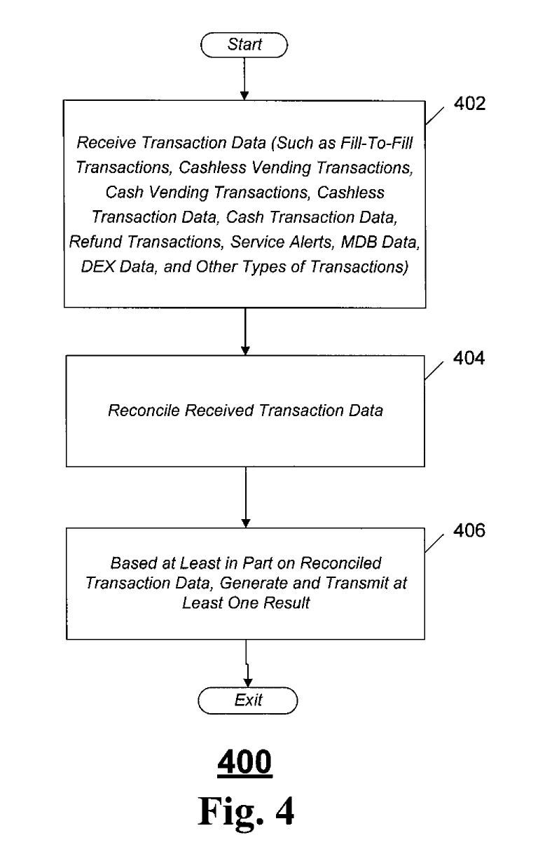

Referring now to FIG. 1, an example of a system such as a vending network data management system 100 in accordance with an embodiment of the invention is shown. Embodiments of the invention can provide systems and methods for providing vending network data management. In general, embodiments of the invention, such as a vending network data management system 100, can use one or more reconciliation tokens to track or otherwise mark any number of transactions handled by the system 100 during communications between at least one server switch and one or more third party servers and/or a settlement engines, such as a vend settlement server or vend settlement server program module. Other embodiments of a system are described in FIGS. 2 and 3, and embodiments of an associated article and method are described in FIG. 4.

In the embodiment shown in FIG. 1, a vending network data management system 100 can include one or more transaction devices 102A-N associated with respective vending equipment 104A-N. Some or all of the transaction-type devices 102A-N can be in communication via at least one network, such as 106, with one or more server switches, such as 105A-N. In one embodiment, one or more transaction-type devices 102A-N can be in communication with each other via one or more networks, such as 106.

Transaction-type devices 102A-N can be any processor-type device, and may be referred to individually as a data processing device. Some or all transaction-type devices 102A-N can be operable to receive and transmit data associated with at least one cash and/or cashless transaction, or a consumer. Such data may be referred to as transaction data. Transaction data can include, but is not limited to, vending equipment load-to-load (also referred to as fill-to-fill) information, vend transaction matching and reconciliation processing data, electronic fund transaction (EFT) reconciliation data, cash vending transactions, cashless vending transactions, cashless transaction data, cash transaction data, transaction records, DEX data, MDB data, transaction refunds (also referred to as reversals) data, accounting data, auditing data, electronic funds charge back data, route management data, business management data, and any other type of data associated with a vending equipment transaction or a consumer. Examples of transaction-type devices can include, but are not limited to, a cash transaction reader, a cashless transaction reader, a combination cash and cashless transaction reader, a RFID reader, a biometric reader, an energy management system (EMS)-type device, a vending machine controller (VMC), and any other type of payment transaction devices. In some instances, a transaction device can be manufactured by HP™, DELL™, IBM/LENOVO™, and GATEWAY™, and may operate software provided by MICROSOFT™, and LINUX™.

In one embodiment, a transaction-type device, such as 102A, can be a payment device operable to accept a cash and/or cashless payment from a consumer, and further operable to facilitate the dispensing of goods and/or services from associated vending equipment, such as 104A. In another embodiment, a transaction-type device, such as 102A, can be a vending equipment controller operable to facilitate the operation of associated vending equipment, such as 104A.

Vending equipment 104A-N can include, but is not limited to, a product or beverage dispenser, a vending machine, a snack dispenser, a device capable of dispensing or providing a consumable food or drink item, a device capable of dispensing or providing a non-consumable item, or a device capable of facilitating purchase of a good and/or service. Vending equipment, such as 104A, can also be referred to individually as a vending machine. In some embodiments, vending equipment 104A-N may conform to vending industry standards including, but not limited to, the National Automatic Merchandising Association (NAMA) MDB specification, and the European Vending Association (EVA) DEX specification. In one embodiment, vending equipment 104A-N can include a vending industry standard-type multi-drop-bus (MDB) interface, and/or a data exchange (DEX) interface.

In one embodiment, multi-drop-bus (MDB) data can be collected from vending equipment, such as 104A-N, and the collected MDB data used to form transaction data records. In this regard, MDB data can include, but is not limited to, inventory, product pricing, and other data during vend events that can be combined with payment ID (for example a PIN number or credit card number) to form a transaction record. In addition, MDB data can be collected during non-vend events and used to form transaction records such as service requests, energy management records, and other types of transaction records.

In the embodiment shown in FIG. 1, a network 106 can be wired or wireless-type network, and may be more than one network to facilitate both wired and wireless-type communications between system components. The network 106 shown in FIG. 1 is shown by way of example. Examples of a network 106 can include, but are not limited to, a local area network (LAN), a wide area network (WAN), the Internet, a global network, a wireless network, a wired network, and any combination thereof. Wireless network communications can be implemented, for example, by way of GSM, GPRS, CDMA2000, 1XRTT, EDGE, 802.11 types and kinds including but not limited to ‘a’, ‘b’, ‘g’, ‘n’, 900 MHz, 2.4 GHz, 5 GHz, spread spectrum, open wireless standards, proprietary wireless techniques, 3G, 3.5G, 4G technologies (‘G’ stands for generation), and any other wireless-type communication device, standard, or methodology. Wired network communications can be implemented, for example, by way of Ethernet, Firewire, serial communications, USB, RS232, and any other wired-type communication device, standard, or methodology. In one embodiment, a network can be the Internet, which may be referred to as a global network.

In the embodiment shown, a server switch 108A can be a processor-based platform, such as a server. In one embodiment, a server switch 108A can be operable to store a copy of some or all of transaction data received from one or more transaction devices 102A-N. The server switch 108A may store some or all of the transaction data in an associated database or data storage device, such as 110, 112, or 114. In another embodiment, a server switch, such as 108A, can be operable to generate a unique identifier, such as a reconciliation token, and associate the unique identifier or token with or otherwise add the unique identifier or token to a transaction record. In some embodiments, a server switch, such as 108A, can generate and associate a unique identifier or reconciliation token with some or all transactions which may be transmitted via a network, such as 106, by the system 100.

As shown in FIG. 1, the system 100 can also facilitate communications with one or more servers 116, 118, 122 and/or third parties 120. In the embodiment shown, some or all of the transaction-type devices 102A-N can be in communication with at least one of the following: a vend settlement server 116, a data services server 118, a financial institution 120, a third party server 122, and/or any device associated with a third party. In this embodiment, a transaction-type device, such as 102A, can transmit data via a network, such as 106, to a server switch, such as 108A. The server switch 105A can selectively transmit some or all of the received data to another transaction-type device, such as 102N; another server switch, such as 108N; a vend settlement server, such as 116; a data services server, such as 118; a financial institution, such as 120; a third party server, such as 122; or any other device associated with a third party. Data received by a vend settlement server 116, a data services server 118, a financial institution 120 and/or a third party server 122 can be stored in an associated database, such as 109, or other data storage device.

In one embodiment, a transaction-type device, such as 102A, can transmit data to a vend settlement server, such as 116, via a network, such as 106, and server switch, such as 108A. Data initially received or otherwise collected by the transaction-type device 102A can be transmitted to the server switch 108A in a format such as a data packet 124. The data can include, but is not limited to, vending equipment load-to-load (also referred to as fill-to-fill) information, vend transaction matching and reconciliation processing data, electronic fund transaction (EFT) reconciliation data, cash vending transactions, cashless vending transactions, cashless transaction data, cash transaction data, transaction records, DEX data, MDB data, transaction refunds (also referred to as reversals) data, accounting data, auditing data, electronic funds charge back data, route management data, business management data, and/or any other type of data associated with a vending equipment transaction or a consumer. Ultimately, some or all of the data can be transmitted by the server switch, such as 108A, to a vend settlement server, such as 116.

In one embodiment, one or more reconciliation tokens can facilitate auditing some or all of the transaction data handled by one or more vend settlement servers 116 and/or third party servers 122. For example, a server switch, such as 108A, can communicate at least one reconciliation token with each transaction to a vend settlement server 116 and/or third party server 122, and receive transaction data from the vend settlement server 116 and/or third party server 122 in response to each reconciliation token. In this example, a server switch 108A can transmit at least one reconciliation token in a data packet 126 to a vend settlement server 116 and/or third party server 122. In response to the receiving one or more reconciliation tokens, the vend settlement server 116 and/or third party server 122 can transmit a data packet 128 with response data including the one or more reconciliation tokens to the server switch 108A. Such response data can be compared to previously transmitted transaction data or other data previously stored in a database, such as 110, 112, or 114, or other data storage device associated with the server switch 108A. In one embodiment, a vend settlement server such as 116 can be referred to as a third party server and can be audited in a similar manner described above.

Furthermore, in one embodiment, a server switch, such as 108A, can be operable to switch or otherwise transfer one or more transaction records between various destination servers. For example, transaction data stored on a particular server can be transferred to another server by way of a server switch, such as 108A. Moreover, a server switch 108A can be operable to issue a data packet 130 with one or more reconciliation tokens in response to transaction data received or transmitted by the server switch 108A. In addition, a server switch 108A can be operable to maintain at least one transaction database for storing transaction data, such as a plurality of databases including a KO database 110, reconciliation database 112, and device database 114.

In one embodiment, a server switch, such as 108A, can be operable to control access to a network, such as 106, by inspecting each transaction received at the server switch 108A. For example, before passing transaction data from a transaction-type device, such as 102A, to a destination location, the server switch 108A can check a database, such as the device database 114, to ensure that the transaction-type device, for instance 102A, from which the transaction is received is allowed to use the network 106. If the transaction-type device 102A is not allowed to use the network 106, the transaction data is not forwarded to the destination location and optionally the transaction-type device 102A can be informed by the server switch 108A that access to the network 106 is denied.

In another embodiment, a server switch, such as 108A, can be operable to control the types or classes of transactions a particular transaction-type device, such as 102A, is allowed to transmit on a network, such as 106. In this regard, the server switch 108A can inspect the type or class of transaction being transmitted, compare each transaction type or class to one or more allowed types or classes of transactions stored in a database, such as device database 114, and determine if such a transaction is allowed from the particular transaction-type device 102A. For example, if a transaction-type device 102A is deployed to accept a particular class of transactions, such as hotel room key cards, the server switch 108A can prevent or otherwise limit all other transactions, such as non-hotel room key cards, from being used.

As shown in FIG. 1, a vend settlement server, such as 116, can include a vend settlement manager program module 132. The vend settlement manager program module 132 can be a set of computer-executable instructions stored in a processor or memory associated with the vend settlement server 116. The vend settlement manager program module 132 can be operable to receive one or more electronic transactions from at least one transaction-type device, such as 102A-N. Furthermore, the vend settlement manager program module 132 can be operable to reconcile one or more electronic transactions. In addition, the vend settlement manager program module 132 can be operable to communicate response data for each electronic transaction to at least one server switch, such as 108A. In some embodiments, a vend settlement manager program module can be stored in other computer-readable media, such as memory or data storage devices associated with other servers, databases, or other processor-based or storage-based devices including, but not limited to, 108A-N, 109, 110, 112, 114, 118, 120, 122, 134. In this manner, a system such as 100 can facilitate providing vending network data management in accordance with embodiments of the invention as described herein.

Referring to FIG. 2, an example system 200 for providing vending network data management in accordance with an embodiment of the invention is shown. The system 200 can be implemented using some or all of the system components shown in FIG. 1, and in this example, some of the system components of system 100 are utilized.

In the embodiment shown in FIG. 2, a vend settlement server, such as 116, can provide some or all operational and financial data processing for an associated operator server, such as 134. An operational server can be operable to manage vending equipment, such as 104A-N, and/or one or more associated vending routes. The vend settlement server 116 can be operable to coordinate the reconciliation of coins, bills, cashless transactions, and other types of inventory management data. As shown, the vend settlement server 116 can communicate with the operator server 134. With data provided by the vend settlement server 116, the operator server 134 can provide route management for vending equipment, such as 104A-N, including, but not limited to, reporting, route management, accountability, service, financial management, business analysis, asset management, product inventory management, and data processing. In this regard, a vend settlement server such as 116 can be operable for money reconciliation, pre-cashless settlement processing (determining the revenue cashless transactions should produce), post settlement processing (determining the revenue actually received from cashless transaction processing—as an example from EFTs), and coordinate the delivery of funds, inventory, and other vending equipment data to an associated operator server such as 134.

In operation, the operator server 134 can communicate with the vend settlement server 116. Initially, transaction data from one or more transaction-type devices, such as 102A, and associated vending equipment, such as 104A, can be received or otherwise collected by the server switch 108A. The server switch 108A can communicate further as needed or desired with a data services server, such as 118 and/or a third party such as a financial institution 120. As discussed previously, transaction data can be communicated by the server switch 108A to the vend settlement server 116 for processing and/or storage. Optionally, a vend settlement server, such as 116, can utilize one or more databases to store data as may be required or desired, such as a database 109. In any instance, the vend settlement server 116 can communicate with the operator server 134 to handle some or all of the following activities: reconciliation of coins, bills, cashless transactions, and other types of inventory management data; reporting; route management; transaction accountability; service; financial management; business analysis; asset management; product inventory management; data processing; money reconciliation; pre-cashless settlement processing (determining the revenue cashless transactions should produce); post settlement processing (determining the revenue actually received from cashless transaction processing—as an example from EFTs); and coordinate the delivery of funds, inventory, and other vending equipment data.

In this manner, reconciliation of bills, coins, and cashless transactions can be synchronized with the product or inventory that a route operators fills the vending equipment with, or otherwise restocks the vending equipment with. Delays in processing certain types of cashless transactions, such as credit card transactions, can result in less than 100% accountability of payment detail (bills, coins, and cashless revenues) at the time the route operator is restocking the vending equipment. As such, the ability to determine what has been sold and paid for can be difficult to determine at any given time and especially when cashless transactions are delayed by processing, such as pending electronic funds transfers (EFTs). In addition, the inability to accurately determine what has been purchased from the vending equipment can cause the route personnel to incorrectly select the restock product to load on to the route truck before traveling to the vending equipment location, which may cause too much or too little restock product to be carried on the route for subsequent restocking.

Referring to FIG. 3, an example article comprising at least one program module 132 or set of computer-readable instructions operable to effectuate vend settlement of at least one vending machine in accordance with an embodiment of the invention is shown. In one embodiment, an article or at least one program module 132 can be implemented by a vend settlement server, such as 116, or other suitable processor-based, computing, or client-type device.

In one embodiment, an article can be a program module or set of computer-readable instructions embodied in a computer-readable medium, such as software. For example, an article can be a program module such as a vend settlement manager program module 132 operable to be executed by at least one vend settlement server, such as 116. In this embodiment, the vend settlement manager program module 132 can receive, reconcile, and/or generate transactional data from one or more data sources including, but not limited to, vending machines, financial institutions, and/or other data processing resources or servers. In one embodiment, transactional data can be obtained from or otherwise stored for subsequent retrieval in any number of data storage devices or databases, such as 109, 110, 112, and 114 shown in FIG. 3 accessible via a network 106 or in direct communication with an associated vend settlement server 116. The vend settlement manager program module 132 can process the transactional data, and can communicate with an operator server, such as 134, to effectuate vend settlement of one or more vending machines and/or allow user accessibility to some or all of the transactional data via one or more data processing devices 136A-C. Such data processing devices can include, but are not limited to, a personal data assistant (PDA), a client-type device, a computer, a laptop, a server, a wireless phone, and/or other types and kinds of data processing devices. Such data processing devices 136A-C can communicate directly with an operator server, such as 134, and/or communicate by way of a network, such as 106 or the Internet.

A program module, such as a vend settlement manager program module 132, can be encoded in a variety of computer languages including, but not limited to, JAVA, PERL, PHP, PYTHON, C, C#, C++, VB.NET, VISUAL BASIC, scripting languages, assembler code, or any other type of programming language and or scripting language. A program module can be referred to, individually or collectively, as software, computer code, data, files, object files, or assembler code applications and can be embodied on any suitable machine readable medium. A machine readable medium can include, but is not limited to, a CDROM, DVD, a hard drive, a micro drive, flash memory, memory, a disk drive, a networked device, a data processing device, a data processing resource, and other types of computer-readable mediums. In one embodiment, various functions or code associated with a program module such as vend settlement manager program module 132 could be distributed between multiple processing devices, such as vend settlement server 116 and another server, or may reside in a single processing device, such as 116.

In one embodiment, informational data processed by a vend settlement manager program module 132 can include, for example, cashless transaction data, electronic funds transfers (EFT), DEX data, MDB data, service alerts data, coin transactions, bill transactions, other types of transactional data, and other desired or required data. Coin transactions and bill transactions can be referred to, individually or collectively, as non-cashless transactions.

In at least one embodiment, a vend settlement manager program module, such as 132, can be implemented in a standalone server. In another embodiment, a vend settlement manager program module, such as 132, can be incorporated into a backend server in communication with one or more other servers, such as third party server 122. In yet another embodiment, a vend settlement manager program module, such as 132, can be incorporated into an operator server, such as 134, to manage transactional and/or operational data, and provide various results to other functions of the operator server 134. In yet another embodiment, a vend settlement manager program module, such as 132, can be incorporated into wired or wireless handheld data processing devices, and can be incorporated into other types of processor-based or client-type platforms as may be required and/or desired.

For example, in one embodiment, a vend settlement manager program module, such as 132, can coordinate reconciliation between fill-to-fill transaction information, cashless vending transactions, and electronic funds transfers communicated from vending equipment and other data processing resources, such as financial institutions. Fill-to-fill transactions can be generated when a service person or other user refills or restocks vending equipment, such as 104A-N. In general, at that time, the vending equipment is known to be restocked and a fill-to-fill transaction can be generated to denote the particular instance in time the vending equipment is known to be relatively full.

In this embodiment, one or more products can be vended from the vending equipment 104A-N and cashless transactions can be generated. When a vend settlement (reconciling inventory and money) is performed, the vend settlement manager program module, such as 132, can coordinate the fill-to-fill transactions with the cashless transaction data to determine when the associated vending equipment was restocked. The vend settlement manager program module, such as 132, can also determine which transactions occurred after restock. In addition, the vend settlement manager program module, such as 132, can determine any fees associated with one or more cashless transactions and/or cashless transaction processing. The vend settlement manager program module, such as 132, can further determine which, if any, of the cashless transactions received electronic fund transfers (EFT). The resultant transactional data can be forwarded by the vend settlement manager program module, such as 132, to an operator server, such as 136, or other suitable data processing device to determine remaining inventory and collected monies, thus settling the some or all of the transactions associated with the vending equipment.

In one embodiment, a vend settlement manager program module, such as 132, can receive transactional data from a plurality of data processing devices and/or data that has been routed from vending equipment. Transactional data can include, but is not limited to, DEX data, cashless vending transaction data, cash vending transaction data, and electronic funds transfer data (EFT). The vend settlement manager program module, such as 132, can process some or all of the transactional data, and can forward some or all of the transactional data to an operator server, such as 134, to effectuate settlement of the associated vending equipment. Processing of the transactional data by the vend settlement manager program module, such as 132, can include, but is not limited to, forming cashless transactions, cash transactions, and other types of transactions using in part MDB data, DEX data, and/or other data. In this manner, a vend settlement manager program module, such as 132, is operable to process different types of transactional data, transform the data into suitable data that may be relevant to vend settlement of associated vending equipment. The transformed data can be modeled into one or more suitable formats compatible with data the operational server, such as 134, may already handle such that the vend settlement manager program module may be converting non-conforming data from several sources into a compatible and conforming data structure. The compatible and conforming data structure can be communicated to the operator server, such as 134, to effectuate vend settlement of the associated vending equipment.

In at least one embodiment, a vend settlement manager program module, such as 132, can be executed by a vend settlement server, such as 116, can be operable to perform various tasks to effectuate vend settlement of associated vending equipment. In this manner, tasks including, but not limited to, reconciling fill-to-fill transactions, cashless vending transactions, cash vending transactions, cashless transaction data, cash transaction data, refund transactions, reconciling other types of transactions and data, and communicating DEX data and/or transaction records formed in part by using MDB data and/or DEX data, and communicating other types of data as may be required and/or desired can be performed. In addition, tasks including, but not limited to, processing service alerts, performing operational management of the vending equipment, performing customer service functions, and or processing and/or performing other types of tasks as may be required and or desired can be performed.

In one embodiment, one or more service alerts can be generated by vending equipment, such as 104A-N, or an associated server. Each service alert can indicate at least one service need associated with the vending equipment, or associated server. In this manner, processing service alerts is one example by which the relative health of vending equipment or an associated server can be monitored. When attention is needed for particular vending equipment or an associated server, notification can be provided by way of a service alert.

Referring to FIG. 4, an example of a method of settling transactions associated with vending equipment is shown. The method 400 can be implemented using some or all of the system components shown in FIG. 1, and in this example, some of the system components of system 100 are utilized.

The method 400 begins in block 402.

In block 402, transactional data associated with one or more transactions is received. In this embodiment, transactional data can be transmitted to or otherwise collected or received by a vend settlement manager program module, such as 132. Transactional data can include but is not limited to, data associated with fill-to-fill transactions, cashless vending transactions, cash vending transactions, cashless transaction data, cash transaction data, refund transactions, service alerts, MDB data, DEX data, and other similar types of transactions and data associated with a vending equipment transaction or a consumer.

Block 402 is followed by block 404, in which the vend settlement manager program module reconciles the received transaction data. In this embodiment, a vend settlement manager program module, such as 132, can reconcile or otherwise process received transaction data. Data processing can include, but is not limited to, reconciling transactions, transforming transactional data to a different format, coordinating data, settling accounts, and/or formatting data as needed.

Block 404 is followed by block 406, in which based at least in part on the reconciled transaction data, at least one result can be generated and transmitted. In this embodiment, the vend settlement manager program module, such as 132, can generate and transmit at least one result based at least in part on the reconciled or otherwise processed transaction data. The result can include, but is not limited to, resultant data, transactions, and transaction data. The vend settlement manager program module, such as 132, can communicate the at least one result to an operator server, such as 134, and/or other data processing resources or servers where vend settlement of associated vending equipment can occur. The method 400 ends after block 406.

The capabilities of various embodiments of the invention can be implemented in software, firmware, hardware or some combination thereof.

As one example, one or more aspects of embodiments of the invention can be implemented in an article of manufacture (e.g., one or more computer program products) having, for instance, computer usable media. The media has embodied therein, for instance, computer readable program code as a means for providing and facilitating the capabilities of embodiments of the invention. The article of manufacture can be included as a part of a computer system or sold separately.

Additionally, at least one program storage device readable by a machine, tangibly embodying at least one program of instructions executable by the machine to perform the capabilities of an embodiment of the invention can be provided.

The flow diagrams depicted herein are just examples. There may be many variations to these diagrams or the elements (or operations) described therein without departing from the scope of the invention. For instance, the elements may be performed in a differing order, or elements may be added, deleted or modified. All of these variations are considered a part of the claimed invention.

While various embodiments of the invention have been described, it will be understood that those skilled in the art, both now and in the future, may make various improvements and enhancements which fall within the scope of the claims which follow. These claims should be construed to maintain suitable protection for embodiments of the invention described herein.

The claimed invention is:

1. A system for vending network data management, comprising:
a vend settlement manager program module operable to:
receive a plurality of electronic transactions from at least one transaction-type device;
reconcile the plurality of electronic transactions; and
communicate response data for each electronic transaction to at least one server.

2. The system of claim 1, wherein the vend settlement manager program module is further operable to:
receive a respective unique identifier for each of the plurality of electronic transactions; and
transmit corresponding transaction data for each of the plurality of electronic transactions based at least in part on the respective unique identifier.

3. The system of claim 1, wherein the electronic transactions comprise at least one of the following: fill-to-fill transactions, cash vending transactions, cashless vending transactions, cashless transaction data, cash transaction data, refund transactions, DEX data, transaction records, MDB data, and any combination thereof.

4. The system of claim 1, wherein the vend settlement manager program module is further operable to:
transform electronic transactions from a plurality of transaction-type devices to at least one suitable data processing format.

5. The system of claim 1, wherein the vend settlement manager program module is further operable to:
transmit data associated with some or all electronic transactions to at least one operator server, wherein vend settlement of the electronic transactions can be facilitated.

6. The system of claim 1, wherein the vend settlement manager program module is further operable to:
determine at least one fee associated with a cash or cashless-type electronic transaction.

7. The system of claim 1, wherein the vend settlement manager program module is further operable to:
generate at least one service alert based at least in part on data associated with an electronic transaction for a particular transaction-type device or vending equipment.

8. A method for providing vending network data management, the method comprising:
receiving a plurality of electronic transactions from at least one transaction-type device;
reconciling the plurality of electronic transactions; and
communicating response data for each electronic transaction to at least one server.

9. The method of claim 8, further comprising:
receiving a respective unique identifier for each of the plurality of electronic transactions; and
transmitting corresponding transaction data for each of the plurality of electronic transactions based at least in part on the respective unique identifier.

10. The method of claim 8, wherein the electronic transactions comprise at least one of the following: fill-to-fill transactions, cashless vending transactions, cash vending transactions, cashless transaction data, cash transaction data, refund transactions, DEX data, transaction records, MDB data, and any combination thereof.

11. The method of claim 8, further comprising:
transforming electronic transactions from a plurality of transaction-type devices to at least one suitable data processing format.

12. The method of claim 8, further comprising:
transmitting data associated with some or all electronic transactions to at least one operator server, wherein vend settlement of the electronic transactions can be facilitated.

13. The method of claim 8, further comprising: determining at least one fee associated with a cash or cashless-type electronic transaction.

14. The method of claim 8, further comprising:
generating at least one service alert based at least in part on data associated with an electronic transaction for a particular transaction-type device or vending equipment.

15. A computer-readable medium comprising program instructions operable to:
receive a plurality of electronic transactions from at least one transaction-type device;
reconcile the plurality of electronic transactions; and
communicate response data for each electronic transaction to at least one server.

16. The computer-readable medium of claim 15, wherein the program instructions are further operable to:
receive a respective unique identifier for each of the plurality of electronic transactions; and
transmit corresponding transaction data for each of the plurality of electronic transactions based at least in part on the respective reconciliation token.

17. The computer-readable medium of claim 15, wherein the electronic transactions comprise at least one of the following fill-to-fill transactions, cashless vending transactions, cash vending transactions, cashless transaction data, cash transaction data, refund transactions, DEX data, transaction records, MDB data, and any combination thereof.

18. The computer-readable medium of claim 15, wherein the program instructions are further operable to:
transform electronic transactions from a plurality of transaction-type devices to at least one suitable data processing format.

19. The computer-readable medium of claim 15, wherein the program instructions are further operable to:
transmit data associated with some or all electronic transactions to at least one operator server, wherein vend settlement of the electronic transactions can be facilitated.

20. The computer-readable medium of claim 15, wherein the program instructions are further operable to:
determine at least one fee associated with a cash or cashless-type electronic transaction.

21. The computer-readable medium of claim 15, wherein the program instructions are further operable to:
generate at least one service alert based at least in part on data associated with an electronic transaction for a particular transaction-type device or vending equipment.
